(19) United States
(12) Patent Application Publication
(10) Pub. No.: US 2013/0065021 A1
(43) Pub. Date: Mar. 14, 2013

(54) Roofing Materials with Metallic Appearance

(71) Applicant: BASF Catalysts LLC, Florham Park, NJ (US)

(72) Inventors: Michael Edison, Ledgewood, NJ (US); Gregory R. Coughlin, Springfield, NJ (US); Doreen C. Becker, Pleasantville, NY (US)

(73) Assignee: BASF CATALYSTS LLC, Florham Park, NJ (US)

(21) Appl. No.: 13/668,810

(22) Filed: Nov. 5, 2012

Related U.S. Application Data
(63) Continuation of application No. 12/582,203, filed on Oct. 20, 2009.

(51) Int. Cl. B32B 9/04; B32B 27/32; B32B 27/14; B32B 27/30; B29D 11/00; B32B 5/16

(52) U.S. Cl. 428/149; 264/1.6; 428/143

(57) ABSTRACT

Provided are materials and methods related to a roofing material comprising at least two layers of polymeric materials, a top layer exposed to the environment and a bottom layer contacting the roof structure, the top layer including an amount of metallic appearing special effect pigment material to impart a metallic appearance. The polymeric material may be a thermoplastic olefin resin, a polyvinyl chloride resin, or other material. Additionally, the polymeric materials contain UV stabilizers and/or flame retardants, smoke suppressants or other fillers.

### CROSS-REFERENCE TO RELATED APPLICATIONS

This application is a continuation of U.S. application Ser. No. 12/582,203, filed Oct. 20, 2009, pending, which claims the benefit of U.S. Provisional Application No. 61/106,709, filed Oct. 20, 2008, and U.S. Provisional Application No. 61/150,068, filed Feb. 5, 2009, the entire disclosures of which applications are incorporated herein by reference.

### FIELD OF THE INVENTION

Disclosed are roofing materials having a unique appearance, and in particular a metallic appearance. In addition, the materials have increased solar reflectance properties.

### BACKGROUND

The roof is an integral part of a building structure since the earliest history of mankind. Roofing materials that are the basis of roofing structures come from many different varieties. Since the roof is directly exposed on the top surface of the building structure, one needs to carefully consider the composition of the roofing materials. Although man has been making roofs out of all kinds of materials, from palm fronds to ancient quarried slates, since the earliest days of mankind, certain roofing materials impart qualities suitable for various environmental challenges and climate conditions. For example, in less developed countries, straw roofing may be used. But in geographies where it may vary in weather conditions and seasons, more solid and heat absorbing/reflecting materials may be more appropriate. In certain areas, the multi-billion dollar roofing industry may find it particularly useful and environmentally friendly to employ roofing materials of other desirable features.

Roofing materials such as wood, slate, or metal can be coated or covered by using various means such as shingling or paint. A metallic composition or look can be advantageous due to reflective properties and heat shielding ability, among other insulative properties. Useful desired insulative properties can include low thermal conductivity and delayed build-up of heat. However, the most ideal results are not usually obtained using metals themselves.

Effect pigments, also known as nacreous pigments and pearlescent pigments, are lustrous specialty chemical products that are widely used in a variety of high-end applications such as automotive finishes. Effect pigments simulate pearly luster or have effects that range from silky sheen to metallic luster as disclosed in L. M. Greenstein, “Nacreous (Pearlescent) Pigments and Interference Pigments”, THE PIGMENT HANDBOOK, Volume 1, Properties & Economics, Second Edition, Edited by Peter A. Lewis, John Wiley & Sons, Inc. (1988). One of the attributes of the effect pigments is that they can generate a range of optical effects depending on the angle at which they are viewed.

Pearlescent or nacreous pigments simulate the effect of natural pearl and are composed of thin platelets which are transparent in the visible region of the spectrum. The platelets are very smooth and part of the light which strikes the platelets is reflected and part is transmitted through the platelets. That part of the light that is transmitted is subsequently reflected by other layers of platelets. The result is that multiple reflections from many layers occur and this results in depth of sheen since the eye cannot focus on one particular layer.

The reflection that occurs in these types of pigments is specular in that the angle of incidence equals the angle of reflection. The amount of light reflected at non-specular angles is small and the amount of light reflected diminishes very quickly as the specular angle is passed. The result is that pearlescent pigments are extremely sensitive to viewing angle. In order for the maximum amount of light to be reflected, the platelets must be extremely smooth. Any surface roughness causes light to be scattered in a non-specular manner and diminishes the lustrous effect.

The platelets must be aligned parallel to each other and to the substrate for maximum reflectivity. If not so aligned, light will be reflected randomly and again, luster will diminish The amount of light that is reflected depends on the index of refraction. As the index of refraction increases, the amount of reflected light increases.

However, in a number of applications, the effect materials have a lesser degree of hiding power than desired. To remedy this problem, a variety of materials have been incorporated in effect pigment formulations.

Effect pigments are often based on platelet shaped particles. Because the optical effect is the result of multiple reflections and transmission of light, it is desirable to provide particles that will align in the medium in which they are found and to optimize the desired effect. The presence of either misaligned particles or particles of an additive, or both, interferes with this objective and diminishes the optical effect of the pigment. It is therefore generally considered to be desirable for any additive being used for increased hiding to be somehow bound to the platelets rather than present as part of a physical mixture.

Effect pigments, particularly pigments based on mica, have long been used in automotive top coats in order to achieve a colored metallic effect, among other reasons. That metallic effect can be characterized by the flip-flop of light to dark as the viewing angle is changed. In the case of mica pigments, that flip-flop is from the reflection color of the mica to dark. In one example, most automotive top coats are required to be opaque to ultraviolet light and also to visible light when applied at a conventional thickness of about 0.5 to 1.2 mils (about 12.7-30.5 microns) for a variety of reasons. One “mil” equals 1/1000 inch (a thickness unit of film) It has been a challenge to maintain the “face” or reflection color which is contributed by the mica pigment while at the same time developing hiding in that it is known that opaque pigments greatly reduce the color/effect of the mica pigments.

Metallic flake pigments such as aluminum are opaque to light, i.e., no light is transmitted. Because of the preceding property, metallic flake pigments cover well and thus, the substrate over which they are coated can be completed hidden. This property is known as hiding power.

Blends of aluminum metal pigments with mica pigments (such as TiO₂-coated mica pigment) are well known for diverse applications. For instance, U.S. Pat. No. 6,503,965 teaches an ink which can contain a non-fluorescent pigment alone or a mixture of two or more non-fluorescent pigments which can be selected from a long list of such pigments, including aluminum flake pigments (with thickness ranging from about 0.1 to about 2 microns) and TiO₂- and Fe₂O₃-coated mica pigments. U.S. Pat. No. 2,278,970 teaches that thin mica flakes are suitable for use as an inert filler in combination with aluminum flake pigment to extend the covering quality of the latter. U.S. Pat. No. 6,331,326 teaches coating a primer and/or a first metallic paint containing a non-leafing type aluminum flake, and then applying a second metallic paint containing small thin flakes. The primer can be blended with a flat pigment, such as the thin aluminum flakes as well as flaky mica, to increase hiding power or hiding sand scratches on the substrate. U.S. Pat. No. 6,306,931 teaches the use of preferred aluminum flake pigments that have median particle size of about 100 microns or less or especially 10 microns or less for incorporation into a coating. U.S. Pat. No. 6,398,861 teaches the use of an aluminum flake pigment having a diameter range of 6 microns to 600 microns for coatings. Silberline.com advertises that its vacuum metallized aluminum flake can be used in cosmetics to achieve a smooth, mirror-like metallic effect and to deliver highly reflective, brilliant finishes.

Blends of aluminum with non-effect materials are also known. For example, U.S. Pat. No. 4,937,274 teaches mixing aluminum flake pigments with ultrafine materials such as titanium dioxide. This coating composition does not include any interference (effect) mica pigments but is said to be still capable of providing an effect like those coatings containing the interference mica pigments and aluminum flake.

However, metallic flake pigments may not be appropriate or desirable in all applications, such as in roof coverings. In a roofing application, a non-metallic, yet metallic appearing pigment would be more suitable.

Thus, if a way could be found to incorporate metallic appearing effect pigments to polymeric membranes used in roofing materials that would show delayed heat build-up over time via solar reflectance and lowered thermal conductivity, this would represent a useful contribution to the art.

### SUMMARY

One aspect relates to a roofing material comprising at least two layers of polymeric materials, a top layer exposed to the environment and a bottom layer contacting the roof structure, the top layer having incorporated therein an amount of effect pigment material that imparts a metallic appearance. The polymeric materials include thermoplastic olefin resins, polyvinyl chloride resins, EPDM, acrylonitrile-styrene-acrylate (ASA), or other materials. Additionally, the polymeric materials contain UV stabilizers.

In another embodiment, a roofing material is disclosed comprising a shingle having at least two layers of polymeric materials, a capstock layer exposed to the environment and a bottom layer contacting the roof structure, the top layer including an amount of metallic appearing effect pigment material sufficient to impart a metallic appearance.

In another embodiment, a roofing material comprising a shingle having a capstock layer exposed to the environment is disclosed. The capstock layer can include an amount of metallic appearing effect pigment material sufficient to impart a metallic appearance.

Optionally, the polymeric materials contain flame retardants and a smoke suppressant.

In another embodiment, a reflective polymer membrane includes at least one layer of polymeric material including an amount of metallic appearing effect pigment material sufficient to impart a metallic appearance. The effect pigment can be used in an amount of about 0.5% by weight to about 3.0% by weight based on the total weight of the reflective polymeric membrane.

It is expected that polymeric membranes prepared according to the Examples using suitable effects pigments as described herein would be have good total solar reflectance (TSR) in a range of about 20% to about 80%, among other thermal properties. For example, it is expected that polymeric membranes prepared according to the Examples using suitable effects pigments would show delayed heat build-up over time via solar reflectance and lowered thermal conductivity. Thus, in an embodiment, the polymeric membranes prepared as described therein are expected to provide better insulative properties when compared to known roofing materials.

In yet another embodiment, a process is provided for preparing a reflective polymeric membrane, comprising melting of a plastic resin, adding a flame retardant material to the melted resin, adding a metallic appearing effect pigment material sufficient to impart a metallic appearance, and thereby forming the polymeric membrane by low shear extrusion and/or calendaring. The effect pigment material can be added in an amount of about 0.5% by weight to about 3.0% by weight based on the total weight of the reflective polymeric membrane.

### BRIEF DESCRIPTION OF THE DRAWINGS

FIG. 1 depicts a TSR graph of an embodiment of PVC films using metallic appearing effect pigment materials at a level of 1% by weight based on the total weight of the film, measured according to ASTM method E-891.

### DETAILED DESCRIPTION

Various effect pigments are disclosed herein. Various types of effects pigments are applicable. The effect pigment substrate may be mica based, alumina based, metallic based, synthetic mica based and borosilicate based. This listing is provided as exemplary and is not intended to be limiting.

The effect pigment substrate is optionally coated, blended, or combined with metal oxide, such as, for example, titanium dioxide, iron oxide, aluminum oxide, and mixtures thereof, to impart a metallic appearance in the thermoplastic membranes. The thermoplastic membranes containing the effect pigment have the appearance of a metallic-based material. The metallic appearing pigments functions as a pigment additive in the roofing materials. Useful effect pigments are further described in U.S. Pat. No. 7,507,285, which is herein incorporated by reference in its entirety.

Exemplary amounts of effect pigments relative to the entire roofing material, that is, relative to the polymeric layer or membrane, can range from about 0.5% to 3.55%. In an embodiment, the amount of effect pigments is 0.75% to 3.0% relative to the entire roofing composition, that is, relative to the polymeric layer or membrane.

Also disclosed is a roofmg material that is made up of two or more layers of polymeric membrane materials, the top layer being exposed to the environment (the capstock layer) containing metallic or metallic appearing effect pigment materials. The cap stock layer contains the bulk of the UV stabilizers. In an embodiment, the capstock layer contains metal oxides, effect pigments and fire retardants. In a two-layer embodiment, the roofing material may be made of an upper thermoplastic layer over a bottom thermoplastic layer. In an embodiment of multi-layers (or three or more layers), the roofing material may be made of one or several upper thermoplastic layers and one or more bottom thermoplastic layers, with supporting layers in between, for example, a scrim, in between two thermoplastic layers.

The thermoplastic layers have a depth of 20 to 120 mils. In an embodiment, the thermoplastic resin layer can be between 20 to 120 mils thick and the capstock layer can be typically between 20-80 mils.

The roofing membrane is comprised of polymeric membranes. In an embodiment, the polymer's membrane is a thermoplastic olefin resin (TPO). In another embodiment, the polymeric membrane may be a polyvinyl chloride-based resin (PVC). In other embodiments, roofing materials may include EPDM (a rubber, ethylene propylene diene monomer rubber), asphalt, shingles, tiles, metal and coated metal, terra cotta, and clay. Additional roofing materials known to the skilled artisan are also contemplated.

The roofing membrane can preferably contain UV stabilizers. In an embodiment, the UV stabilizer may be a hindered amine light stabilizer (HALS), UV absorbers (organics or inorganics), antioxidants, and temperature stabilizers. Other UV stabilizers are known to those skilled in the art. In an embodiment, the UV stabilizer is used in the capstock layer. Lower levels of UV stabilizer may also be present in base stock layers. Examples of UV stabilizers are commercially available from BASF Corporation (Florham Park, N.J.).

In an embodiment, at least the capstock membrane layer contains IR reflective materials to minimize heat build and effect pigment material to impart metallic appearance.

In an embodiment, the roofing material further contains a flame retardant and smoke suppressant. For example, in an embodiment, magnesium hydroxide can be used. Other flame retardants and smoke suppressants are known to the skilled artisan.

In another embodiment, the metallic appearing effect pigment material may not be incorporated in the TPO/PVC layer itself. Instead, the metallic appearing effect pigment material can be coated on the top or bottom of the TPO/PVC layer as a separate layer.

In an embodiment, the UV stabilizer can be melt compounded into the polymeric materials, as a part of the thermoplastic resin. For example, it can be used (melt compounded in at 0.1-2.5%) in the capstock layer.

In an embodiment, UVINUL® materials, available from BASF Corporation, are the UV stabilizers.

### EXAMPLE 1

A three layer roofing material is produced. Initially, optional non-pigment additives, including optional flame retardant and UV stabilizing additives, are added to the compounding of the thermoplastic in an extruder. IR reflective or transparent pigments are added at the feed throat of the extruder as well as some of the special effect pigment. Effect pigment materials are optionally added later in the process, for example, in downstream feeder, to minimize residence time in order to prevent their destruction by the shear forces of the calendar or extruder equipment which can cause stripping of the optical coating from the substrate resulting in washed out appearance or less of a special effect. The resulting product forms the upper or outer layer of the thermoplastic membrane.

### EXAMPLE 2

Various samples of polymeric membranes useful for roofing membranes that incorporates metallic appearing effect pigments were prepared as in Table 1, and their total solar reflectance were measured (Table 2). A Lambda 950 UV/VIS Spectrophotometer, using ASTM E-891 method was used.

TABLE 1
Composition (100 wt. parts)

| | Components^{1,2} | | | | | |
|---|---|---|---|---|---|---|
| | A | 1 | 2 | 3 | 4 | 5 |
| Mearlin ® Sparkle | 0.4 | 0.40 | 0.24 | 0.16 | 0.16 | 0 |
| Bronze 9250J | | | | | | |
| Mearlin ® Sparkle | 0 | 0.40 | 0 | 0 | 0 | 0.08 |
| Copper 9350 J | | | | | | |
| Lumina ® Brass 9232D | 0.4 | 0 | 0.8 | 0.88 | 0.88 | 0.88 |
| Magna Pearl ® 1000 | 0.4 | 0 | 0 | 0 | 0 | 0 |
| Magna Pearl ® 5000 | 0 | 0.40 | 0.16 | 0.16 | 0.16 | 0.12 |
| Meteor ® Plus Black 9887 | 0 | 0.04 | 0.04 | 0 | 0.02 | 0 |
| Magnesium hydroxide, | 49.4 | 49.4 | 49.4 | 49.4 | 49.4 | 49.5 |
| 70% conc. | | | | | | |
| TPO resin | 49.4 | 49.4 | 49.4 | 49.4 | 49.4 | 49.5 |

¹Mearlin ®, Lumina ®, and MagnaPearl ® effect pigments are products available from BASF Corp.
²Meteor ® Plus inorganic pigment is available from BASF Corp.

TABLE 2

| Characteristic | A | 1 | 2 | 3 | 4 | 5 | Metal target³ |
|---|---|---|---|---|---|---|---|
| Thickness (inch) | 0.026 | 0.025 | 0.025 | 0.025 | 0.025 | 0.024 | 0.031 |
| TSR value (%) | 63.74 | 60.98 | 61.28 | 70.12 | 65.22 | 66.05 | 54.42 |
| % Increase Over Target | 17.1% | 12.0% | 12.6% | 28.8% | 19.8% | 21.4% | — |

³Metallic standard: UNA-CLAD ® KYNAR 500 ®/HYLAR 5000 ® Fluorocarbon-coated Steel Classic Copper, available from Firestone Metal Products (Anoka, Minnesota).

As shown in Table 1, various polymer membranes were produced using diverse combinations of metallic effects pigments.

As shown in Table 2, the prepared polymeric membrane materials exhibit unexpectedly enhanced TSR values when compared to metal target. It is notable that the polymeric membrane materials prepared as in Table 1, Example 2 are generally non-metallic materials, and the effect pigments themselves are non-metallic materials. However, a metallic look or appearance is provided, which is amply demonstrated by the TSR value results.

### EXAMPLE 3

The TPO resin was melt compounded using a single screw, twin screw, buss co kneader, internal mixer or other plastic mixing or compounding equipment. The additives and the pigment can be added at the feed throat of the extruder or even more desirable using a side or downstream feed port. Care was taken to minimize shear and residence time during processing to ensure that the effect pigments remain intact. This was effected by low shear extrusion screws, processing aids, or other means to minimize destruction of effect pigments during processing.

The resin contains the magnesium hydroxide FR (flame retardant) and the UV stabilizing additives, or these additives. In some cases, these additives are introduced earlier via a concentrate or compound production.

One of the compositions comprises:
1-2% effect pigment
30-65% magnesium Hydroxide FR
0.5-3.5% UV stabilizing additives
0.01-2.5% IR reflective or IR transparent pigment
Optionally, 0.1-4.5% TiO₂
Optionally, other additives.

Other additives include: processing aids, process stabilizers, heat stabilizer/antioxidant, and other additives typically used in polymeric membrane roofing applications.

After producing the compound, the membranes are made using film/membrane production equipment such as a calendaring operation. To minimize shear, single layer or co-extrusion process are used.

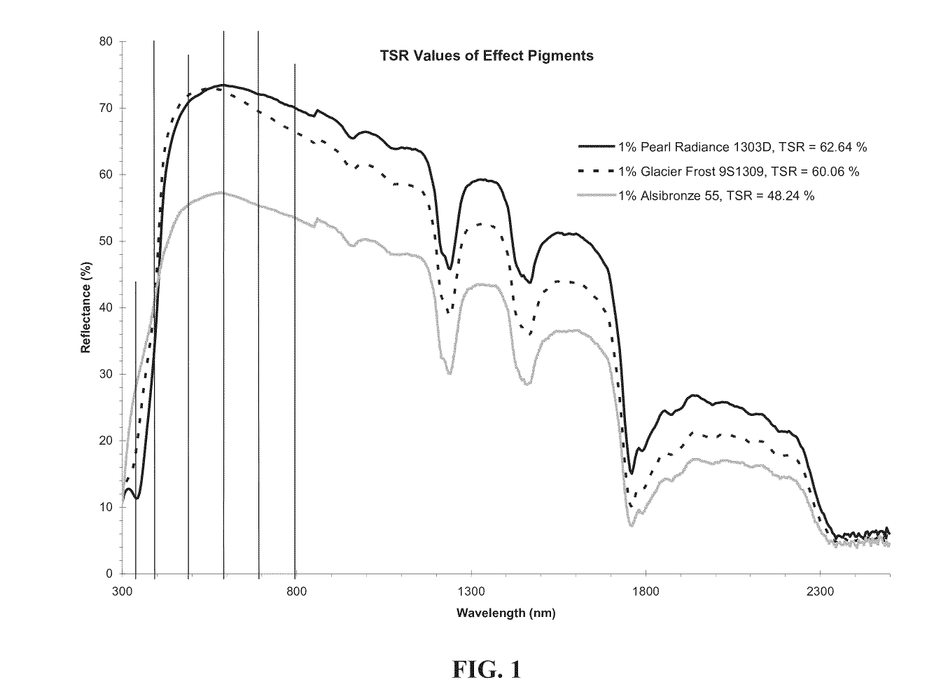

It is expected that polymeric membranes prepared according to the Examples using other suitable effects pigments as described above (e.g. as in FIG. 1) would be have good total solar reflectance (TSR) in a range of about 20% to about 80%, among other thermal properties. For example, it is expected that polymeric membranes prepared according to the Examples using suitable metallic effects pigments, as described above, would show delayed heat build-up over time via solar reflectance and lowered thermal conductivity. Thus, in an embodiment, the polymeric membranes prepared as described therein are expected to provide better insulative properties when compared to known roofing materials.

In one embodiment, a reflective polymeric membrane containing metallic appearing effect pigment material can have a TSR ranging from about 20% to about 80%. In another exemplary embodiment, the reflective polymeric membrane containing metallic appearing effect pigment material can have a TSR ranging from about 40% to about 80%. In yet another embodiment, the reflective polymeric membrane containing metallic appearing effect pigment material can have a TSR ranging from about 50% to about 80%.

All references, including publications, patent applications, and patents, cited herein are hereby incorporated by reference for all purposes to the same extent as if each reference were individually and specifically indicated to be incorporated by reference and were set forth in its entirety herein.

The use of the terms “a” and “an” and “the” and similar referents in the context of describing the materials and methods discussed herein are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value can be incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

It should be understood that the foregoing description is only illustrative of the embodiments. Various alternatives and modifications can be devised by those skilled in the art without departing from the disclosed materials and methods. Accordingly, the materials and methods disclosed embrace all such alternatives, modifications and variances which fall within the scope of the appended claims.

What is claimed is:

1. A roofing material for application to a roof structure comprising at least two layers of polymeric materials, an exposed top layer and a bottom layer contacting the roof structure, the top layer including an amount of metallic appearing effect pigment material sufficient to impart a metallic appearance.

2. The roofing material of claim 1, wherein the top layer comprises a thermoplastic olefin resin.

3. The roofing material of claim 1, wherein the top layer comprises a polyvinyl chloride resin.

4. The roofing material of claim 1, wherein the polymeric materials each independently contain UV stabilizers.

5. The roofing material of claim 1 comprising three layers, wherein a scrim is located between the top layer and the bottom layer.

6. The roofing material of claim 1, wherein the polymeric materials contain a flame retardant and smoke suppressant.

7. The roofing material of claim 1, wherein the metallic appearing effect pigment material is a mica based pigment.

8. A roofing material for application to a roof structure comprising a shingle having at least two layers of polymeric materials, an exposed capstock layer and a bottom layer contacting the roof structure, the capstock layer including an amount of metallic appearing effect pigment material sufficient to impart a metallic appearance.

9. The roofing material of claim 8, wherein the capstock layer comprises a thermoplastic olefin resin.

10. The roofing material of claim 8, wherein the capstock layer comprises a polyvinyl chloride resin.

11. The roofing material of claim 8, wherein the polymeric materials each independently contain UV stabilizers.

12. The roofing material of claim 8 comprising three layers, wherein a scrim is located between the capstock layer and the bottom layer.

13. The roofing material of claim 8, wherein the polymeric materials contain a flame retardant and smoke suppressant.

14. A reflective polymeric membrane for application to a roof structure comprising at least one layer of polymeric material including an amount of metallic appearing effect pigment material sufficient to impart a metallic appearance.

15. The reflective polymeric membrane of claim 14, wherein the effect pigment material is present in an amount of about 0.5% by weight to about 3.0% by weight based on total weight of the reflective polymeric membrane.

16. The reflective polymeric membrane of claim 14, wherein total solar reflectance is from about 20% to about 80%.

17. The reflective polymeric membrane of claim 14, wherein total solar reflectance is from about 50% to about 80%.

18. The reflective polymeric membrane of claim 14, wherein the effect pigment material is a mica based pigment.

19. A process for preparing a reflective polymeric membrane, comprising the steps of:
melting a plastic resin;
adding a flame retardant to the melted resin;
adding a metallic appearing effect pigment material; and
forming the reflective polymeric membrane by low shear extrusion or calendaring.

20. The process of claim 19, further comprising adding at least one UV stabilizer and at least one IR reflective or IR transparent pigment.

21. The process of claim 19, wherein the effect pigment material is added in an amount of about 0.5% by weight to about 3.0% by weight based on total weight of the reflective polymeric membrane.
